(19) United States
(12) Patent Application Publication
(10) Pub. No.: US 2005/0203995 A1
(43) Pub. Date: Sep. 15, 2005

(54) Data communication method

(76) Inventor: Jochen Schumacher, Koln (DE)

Correspondence Address: MEYERTONS, HOOD, KIVLIN, KOWERT & GOETZEL, P.C., P.O. BOX 398, AUSTIN, TX, 78767-0398, US

(21) Appl. No.: 10/997,497

(22) Filed: Nov. 24, 2004

(30) Foreign Application Priority Data
Mar. 9, 2004 (DE) 10 2004 011 242.8

(51) Int. Cl. G06F 15/16

(52) U.S. Cl. 709/203; 709/231

(57) ABSTRACT

A method of data communication of a client program by way of a data network with a server program when a network connection is lacking. The method makes use of a transportable data storage means whose interface can be connected on the one hand to a home computer with no network connection, an inactive connection or a slow network connection, and on the other hand to a communications computer with a present, preferably fast network connection. When the data storage means is connected to the home computer a communication program emulates the functionality of the server program and stores data sent by the client program. When the data storage means is connected to the communications computer the communication program emulates the functionality of the client program and transmits data to the server program.

The invention concerns a method of data communication with a client program, which is intended for data exchange with a server program by way of a data network.

Data communication of individual computers with a server by way of a data network takes place in a large number of situations. For example the workstations in a local network (Local Area Network) communicate by way of the network cabling or by way of radio network connections (wireless LAN) with one or more server computers of the network. A client program runs on each workstation computer and communicates with the program on the server. A further example of client-server communication is data transmission by way of the Internet. Data streams are exchanged with remotely arranged servers by way of the Internet, by communication programs which operate in accordance with a standardized data transmission protocol (for example File Transfer Protocol FTP; Hypertext Transfer Protocol HTTP or Transmission Control Protocol/Internet Protocol TCP/IP). In this case also client programs run on the computers of the Internet users and implement the communication with the respective server.

A particular example of network-based data communication is e-mail distribution (sending electronic messages). In that case a data stream which represents a message is sent from a sender to a receiver either by way of closed networks (Local Area Networks) or by way of the Internet. The computer of the sender runs an e-mail client program which for example is integrated into office organization programs such as MICROSOFT OFFICE® or LOTUS NOTES® or are operated in the form of independent programs, for example under the marks Eudora, Pegasus, or QMail. With an active data connection the e-mail client program communicates with a mail server program, that is to say with the program on a computer of an e-mail provider such as YAHOO®, HOTMAIL®, AOL® or T-online®. At moments in time at which a computer is not on-line, that is to say when there is no active connection with the server by way of the network, the local client program cannot communicate outwardly. Before implementing the data transmission the client program detects whether the network connection is present. If the client program cannot establish a connection to the associated server program by way of the data network, data transmission to the server program is impossible and the corresponding function of the client program cannot be executed.

In the absence of a connection to a data network, transportable data storage means are used as auxiliary means for data transmission. Transportable data storage means of that kind are writable magnetic storage means such as floppy disks or portable hard disks, or writable optical storage means such as writable CDs or DVDs. In recent times re-writable electronic memory components, referred to as flash memories, are also used. Those flash memories are sold with steadily rising memory capacities (at the present time between 16 Megabytes and about 2 Gigabytes) by various manufacturers as memory elements. For example USB memory sticks are currently employed for connection to USB interfaces (USB=universal serial bus) of a computer or another unit. There are also solutions for other data interfaces (for example memory cards for digital cameras).

Data which are stored on a computer which is not connected to the network and which are to be transmitted by way of a data network are copied onto the transportable data storage means. The data storage means is taken to a computer which is connected to the data network. On that computer, the client program is started and used to transmit the data to be transmitted from the transportable data storage means to the server program by way of the network.

That procedure suffers from the disadvantage that it is very inefficient as the user has to occupy himself twice with producing and sending a message or a data packet by way of the data network. On the first occasion, he operates on the computer that is not connected to the network and on that computer has to identify all data sets which are to be transmitted by way of the data network. Those data sets are stored on the transportable data storage means. On the second occasion, the user calls up the client program on a computer which is connected to the data network and which is also referred to as the communications computer. He selects the data sets which are to be transmitted by way of the network and which are stored on the transportable data storage means. In the case of an e-mail communication, an e-mail has to be prepared in the e-mail editor on the communications computer, the selected data sets being enclosed with e-mail as an attachment.

In addition there is the disadvantage that the client program on the computer used for the communication, with a data network connection, possibly involves a configuration which is not associated with the user who would wish to transmit the data. That is the case for example with e-mail communication. In general, an e-mail client program is installed on a computer and configured for that respective user of the computer. A user whose computer does not have a connection to the Internet cannot send messages with the e-mail client configured on his computer. It is therefore not possible to send a message which contains the identification of his computer, including the e-mail address associated with the user. If the user transmits data from his computer without a network connection to the transportable data storage means and carries that data storage means to a different computer with a network connection, for example in an Internet cafe, then the e-mail client of that computer does not involve the configuration associated with the user. The present invention aims to eliminate those disadvantages.

The object of the invention is to provide a method of data communication with a client program, which is intended for data exchange with a server program by way of a data network, when a network connection is not present at least from time to time, which is simple to operate.

In accordance with the invention that object is attained by the features of claim 1.

In other words, there is proposed a method which involves the use of two emulation program modules which automatically implement on the one hand the communication with the client program and on the other hand the communication with the server program. A server emulation program module runs on a home computer of the user on which the data to be transmitted are stored. The server emulation program module emulates the data streams which, in the usual client/server communication, are produced by the server program and sent by way of the data network to the client program. In addition the server emulation program module receives the data streams which are sent by the client program on the home computer and stores them on the transportable data storage means. Finally the server emulation program module possibly sends data which at an earlier moment in time were received by way of the data network by the client emulation program module described hereinafter, and which were stored on the transportable data storage means to the client program on the home computer. During these operations the client program on the home computer operates in the same manner as when there is an active connection by way of a data network with the actual server program. In that way it is possible to effect all usual communication functions from the home computer without an active network connection with the conventional client program. The sent data are only stored on the transportable data storage means and are not sent directly by way of the data network.

That option can be used if the home computer is at a location at which no connection to a data network such as the Internet exists. In addition it is possible to make use of the option if the home computer is set up at a location with a slow Internet access. In that case, transmission of large amounts of data can be effected by using the transportable data storage means, at a high speed. In practice the communication according to the invention can be activated for example by cutting the network access of the home computer.

After the data exchange between the client program on the home computer and the server emulation program module, the data sent by the client program are stored on the transportable data storage means. The transportable data storage means can be taken to a communications computer, that is to say to any computer with a preferably powerful connection to the data network. Here, a client emulation program module is called up, which:
emulates the data streams of the client program and sends them by way of the data network to the server program;
receives the data sent by the server program and stores them on the transportable data storage means, and
possibly sends the data which were previously sent by the client program of the home computer and received by the server emulation program module and stored on the transportable data storage means to the server program by way of the data network.

In that case, the emulated data streams of the client program do not necessarily have to be dispatched by way of a data network, for example not in the particular situation in which the data carrier is connected directly to the computer on which the server program runs.

The client emulation program module therefore controls the data streams in such a way as is usually effected by the client program itself.

The method according to the invention thus makes it possible to implement a data exchange from a computer without an active connection to the data network or with a slow connection to the data network, by the usual use of the client program running on that computer (also referred to as the home computer), as if the computer were connected to the data network. The data sent by the home computer are put into intermediate storage on the data storage means. The data storage means is connected to any computer with access to the network, also referred to hereinafter as the communications computer. There the communication with the server program is automatically executed by way of the data network, in which case a client emulation program module produces the same data streams which were sent by the client program on the home computer. The client program on the communications computer is not involved in that procedure, so that the communication is effected with the identification data of the home computer.

A practical application of the method lies in e-mail communication. The method according to the invention makes it possible to send and receive e-mails in a simple and convenient fashion with computers without an Internet connection, as if the computer were connected to the Internet. The user only has to connect a transportable data storage means, preferably a USB stick, to an interface of the computer, and call up the server emulation program module. The server emulation program module can possibly be started automatically by an autostart function. After the e-mail communication has been effected, wherein the e-mails are stored on the data storage means, the USB stick is taken to a computer with an Internet connection, for example in an Internet cafe. By connecting the USB stick to the USB interface of the communications computer with an Internet connection and calling up the client emulation program module, the data are read out of the data storage means and dispatched to the server by way of the Internet. In that situation the client emulation program module sends the data of the client program of the home computer to the server program by way of the data network. In that respect it is irrelevant whether a client program is installed on the communications computer itself, or how that client program is configured. In other words, when sending e-mail, the identification, for example the e-mail address, the user identification and the password which are inputted in the client program on the home computer are transmitted to the server program by the client emulation program module. The receiver of the e-mail therefore receives a dispatch which corresponds to that which is transmitted directly by a client program of suitable configuration, by way of the data network.

That implementation is very simple. Once the server emulation program module has been configured or installed on the home computer of the user, the user can send and receive e-mails, even if there is no connection to the Internet or if the connection to the Internet is slow, by simply using the client program on the home computer. In addition, after the communication procedure is concluded, it is only necessary for the transportable data storage means to be removed from the home computer and taken to a communications computer and connected thereto. The client emulation program module can be automatically loaded into the main working memory of the communications computer by the autostart function of the operating system thereof, and execute the data communication by way of the data network. There is no need for further intervention on the part of the user in relation to that communication.

The method according to the invention however is not limited to e-mail communication. For example it can also be used for bridging over a lack of data connection to a local data network (Local Area Network=LAN). By way of example a locally processed data file can be stored, using the local network client of a workstation computer, on the server, insofar as the local network client communicates with a corresponding server emulation program module which stores the data on the transportable data storage means. When the data storage means is connected to a communications computer which is connected to the corresponding local network, the data are then transmitted to the server computer of the network. The method according to the invention is suitable for any communication between a client program and a server program by way of a data network.

When using the Internet for data transmission in accordance with the method of the present invention, it may be necessary for a nameserver emulation program to be associated with the server emulation program. A nameserver is a computer which is connected to the Internet and which has access to a database in which the domain names used in the Internet are associated with the numerical Internet addresses (IP addresses). Client programs, before dispatching a data packet, frequently enquire at a nameserver for the IP address which is associated with the domain name which is to receive the message. If the client program is running on a computer which is not connected to the Internet, not only the server but also the nameserver has to be emulated. A domain name which is sent by the client program is received by the nameserver emulation program module and associated with a given IP address which is sent back to the client program. In that situation the domain name is stored on the transportable data storage means, associated with the corresponding communication procedure.

In the later transmission of the stored data from the data storage means by the client emulation program to the server program by way of the Internet, the stored domain name is sent by the client emulation program to a nameserver which then sends back the actual IP address to the client emulation program so that data dispatch to the correct IP address can take place.

At least one of the program modules and preferably all three program modules are stored on the transportable data storage means itself. In that way a transportable data storage means can be used on any computers for carrying out the method according to the invention. The required program modules can be loaded from the transportable data storage means itself into the main memory of the respective computer.

At least one of the specified program modules can be loaded from the transportable data storage means directly and immediately into the main memory of a computer. That procedure is preferred in particular for executing the client emulation program module on a communications computer with a connection to the data network. In that way any computers with an Internet connection or connections to other relevant networks can be used for carrying out the second portion of the method according to the invention, namely data transmission by way of the network to the server, without the respective communications computer having to be configured to carry out the method. When connecting the transportable data storage means, for example by way of a USB interface, to a computer in an Internet cafe or another computer which does not belong to the user, the client emulation program can be loaded from the data storage means into the main memory of the computer without permanently influencing the operating system thereof and without having to store data on the hard drive of that computer. The client emulation program module which is loaded into the main memory transmits the data stored on the transportable data storage means to the receiver by way of the Internet without storing data on the communications computer. That eliminates any risk on the one hand of interfering with operation of the communications computer by changes to the operating system of that computer and by the storage of data on the disk drives of that computer and on the other hand storing confidential data of the user of the transportable data storage means on the disk drives of the communications computer.

In a practical embodiment at least one of the program modules, for example the client emulation program module, can be automatically loaded into the main memory of a computer when the transportable data storage means is connected to that computer. In practice, when connecting a transportable data storage means such as a USB stick to the corresponding USB data interface of the computer the data storage means is recognized as a new drive. Many operating systems, for example the WINDOWS operating systems from MICROSOFT, have an autostart function which, when a new drive is detected, automatically call up certain programs on the drive. That autostart function provides that the client emulation program module can be automatically called up when the data storage means is connected to a new computer for the first time. It is then executed until all data have been transmitted from the data storage means by way of the data network to the corresponding server program and all data received from the corresponding server program have been stored on the data storage means. Optionally, when terminating the communication procedure, an optical and/or acoustic indication of the end of the procedure can occur. It is also possible to indicate by a so-called progress bar, what proportion of the entire communication task has been implemented. After the conclusion of the communication program the program module can be automatically removed from the main memory of the communications computer and the corresponding regions of the main memory are cleared for other programs.

Alternatively or in addition it is possible for at least one of the program modules for carrying out the method according to the invention to be fixedly installed on a computer. That applies in particular to the server emulation program module. That program module is to be called up when the data storage means is connected to the home computer of the user. It generally runs parallel with the nameserver emulation program module so that this too can be fixedly installed on the home computer. The fixed installation of the server emulation program module, possibly coupled with given identification or authentication data (user ID, password, number of the computer and so forth) means that it is possible, upon connecting the transportable data storage means, to automatically check and verify that the computer in question is the home computer of the user. When that information is verified, the server emulation program module is generally started in order to permit the local client program (for example the mail client) to communicate by means of the data storage means. If the computer in question is not the home computer, then generally the server emulation program module should not be started because no client is running on the computer, which is configured for the specific user data of the system and which is set up for communication with the server emulation program module. In addition the user is interested in the data stored on his data storage means not being such that they can be read out by any client program. Therefore the server emulation program module may generally only run on the home computer (an exclusion from this is direct storage, which is described hereinafter, of data on the other external computer, without using the data network).

In a practical embodiment it is also possible for the same communication program to be run on the home computer and on the communications computer, in which case the communication program includes the server emulation program module and the client emulation program module and possibly the nameserver emulation program module. Then, within the communication program, the respectively required modules are activated in dependence on identification or authentication of the computer (for example as the home computer) and in dependence on the presence of a network connection.

Alternatively—as mentioned—either only the server emulation program module or the client emulation program module can be respectively executed on a computer. For that purpose a test program module can check whether the transportable data storage means is connected to the home computer or to a computer connected to the data network. If the data storage means is connected to the home computer the server emulation program module is executed. If the data storage means is connected to the communications computer the client emulation program module is executed. The test program module can in turn be started automatically by way of an autostart function when the data storage means is connected to the interface of a computer.

In practice the specified program modules can be coupled to a function program which executes the data transmission processes and the data conversion processes. The data transmission processes include at least one of the following processes:
reading data out of a data storage means,
writing data into a data storage means,
associating attachments to with given data sets,
erasing data from a data storage means,
verifying complete transmission and storage of data, and
authorizing transmission and reception of data from and to a given counterpart.

Data conversion concerns in particular encryption and/or decryption of data.

Finally, in a special situation, with the software product according to the invention, it is possible to implement data communication between a first client program and a second client program, wherein both client programs are originally intended for data exchange with a server program by way of a data network. In this case also a lack of network connection is to be bridged over. That is effected by using a transportable data storage means and by the following steps:
A) data streams associated with a server program are emulated and sent to the first client program;
B) data streams dispatched by the first client program are received and stored on the transportable data storage means;
C) the data storage means is connected to a computer on which a second client program is running, and
D) the data stored in step B) on the transportable data storage means are sent to the second client program.

In other words, the server emulation program module is started on two different computers on which a respective client program is installed, in order to implement communication with the respective client program. Upon communication with the first client program on the home computer, for example a data transmission such as an e-mail is received, which is directed to the e-mail address for which the second client program is configured. That e-mail is stored on the data storage means, with the further data which is possibly sent by the first client program. When the data storage means is connected to the second computer, the e-mail client of which has the configuration with the specified e-mail address, the server emulation program module sends the e-mail or e-mails with identical items of address information to the second client program. In that way transmission by means of a mobile data storage means from the first home computer to the second receiver computer is possible without sending the data by way of a data network, in which respect however the conventional client programs on the two computers implement the communication in the usual way.

Finally the invention relates to a computer program product which can be loaded directly into the main working memory of a computer and which includes software code portions with which the above-described method steps can be carried out when the program is running on a computer. The term “computer” includes any “intelligent” terminal device with a processor and a working memory, including MP3 players, mobile telephones, PDAs, notebooks, and so forth.

The computer program product can include at least one of the above-described program modules.

Finally the invention concerns a transportable data storage means on which the described computer program product is stored. Transportable data storage means, in particular re-writable electronic memory components, for connection to conventional computer interfaces (in particular USB sticks but also all other data storage means as referred to hereinbefore) are increasingly sold in large numbers and at low prices. Often USB memory sticks of that kind have additional software in order to permit further functions to be performed (for example the function of the MP3 player for playing back music files). Storing the computer program product according to the invention on a USB memory stick of that kind enhances the value and functionality thereof. The USB stick can be used directly for bridging a missing connection to a data network.

An embodiment of the invention is described hereinafter with reference to the example of e-mail communication. It should be emphasized once again that the method according to the invention can be applied to any client server communication situations and is not limited to the example of e-mail communication.

The embodiment by way of example is described with reference to the accompany drawings in which:

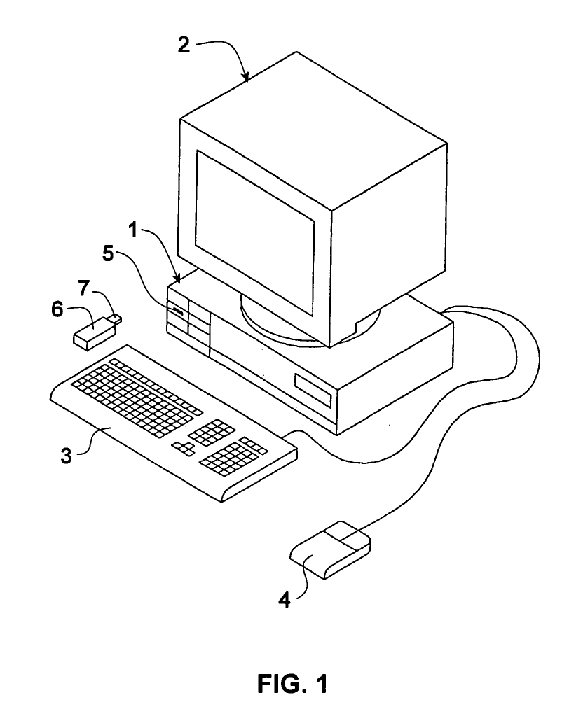

FIG. 1 is a view by way of example of a hardware arrangement for carrying out the method according to the invention,

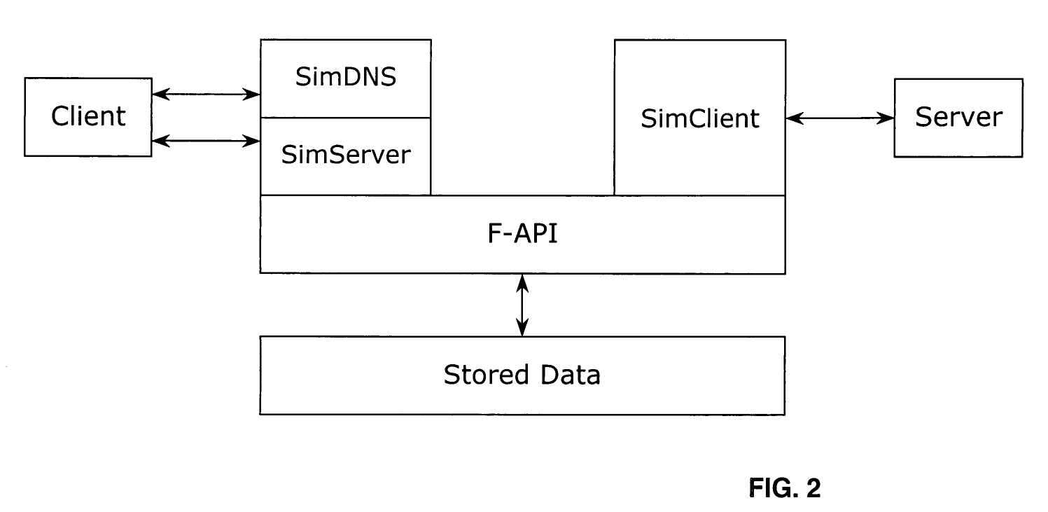

FIG. 2 shows a block diagram of the program modules used in the method according to the invention,

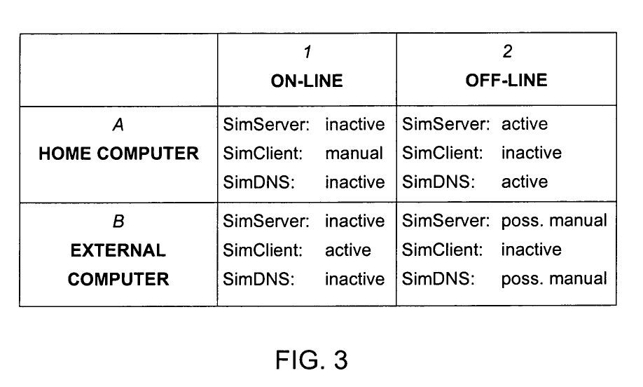

FIG. 3 shows a matrix on which the activation of various program modules of the software according to the invention is associated with various situations, and

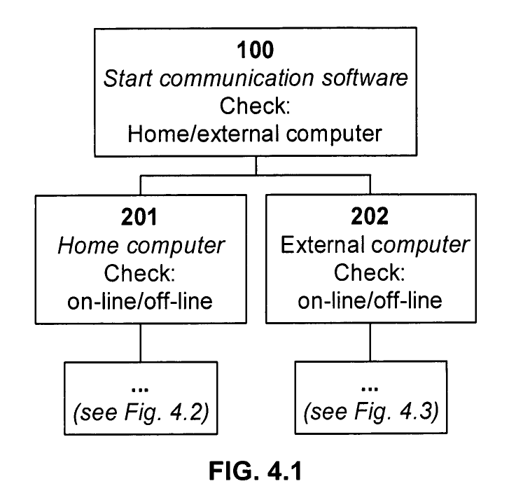

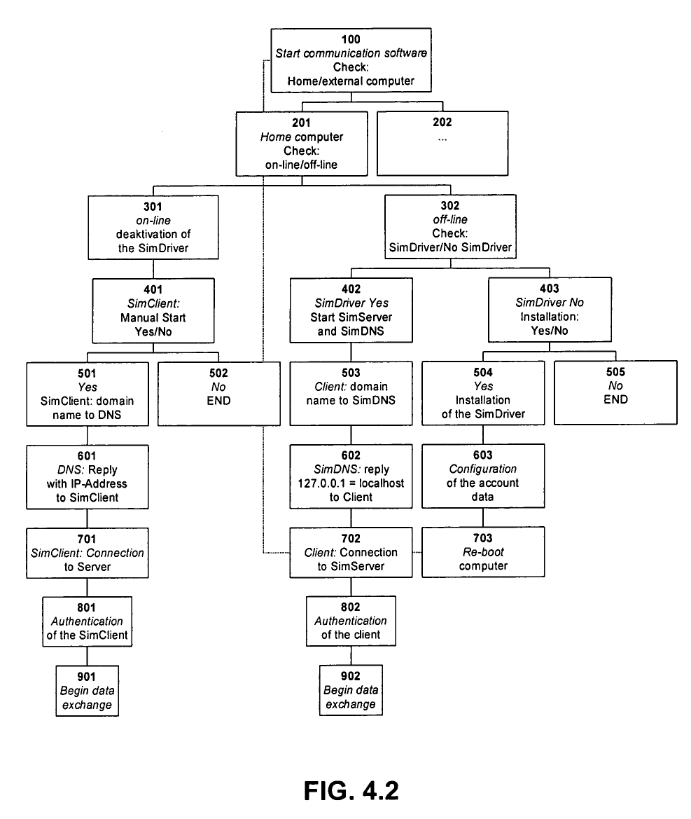

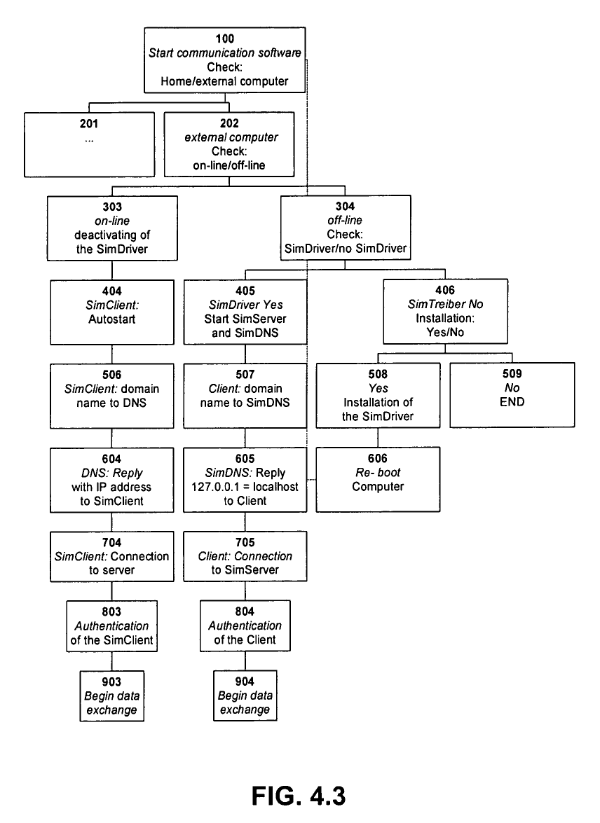

FIGS. 4.1-4.3 show a flow chart which illustrates the successive steps of the communication program according to the invention.

FIG. 1 shows a conventional personal computer 1 with the usual components (hard drive, motherboard with CPU and main working memory, interfaces, power supply unit and so forth). The drawing shows on top of the casing of the computer 1 a screen 2 which is connected to the computer 1 and which forms a display device. Also connected to the computer 1 are input devices, in the present case a keyboard 3 and a mouse 4. The interfaces of the computer are usually in the form of plug sockets. In the present case in particular a USB interface 5 is shown at the front side of the computer. In addition FIG. 1 shows a so-called USB memory stick 6 forming a transportable data storage means. The USB memory stick 6 comprises a flash memory (re-writable electronic memory device) which is connected to a USB plug 7, wherein the memory device, the USB plug 7 and the electronic circuits which connect the memory device to the USB plug are arranged in a common plastic casing. When the USB plug 7 is inserted into the USB interface 5 of the computer 1, a driver is automatically loaded into the main memory of the computer 1, which detects the USB memory stick 6 as a new drive.

To use that hardware for carrying out the method according to the invention, a communication program is stored on the USB memory stick 6. The various function blocks of that communication program can be seen from FIG. 2. The communication program serves for data exchange on the one hand with a client program which is often referred to as the “client” in FIG. 2 and in the text hereinafter, and on the other hand to a server program, by way of a data network, the server program also being referred to as the “server” in FIG. 2 and in the text hereinafter. The communication program comprises the blocks SimServer, SimClient, SimDNS and F-API. Those program modules perform the functions described hereinafter.

Server Emulation Program Module (Simulated Server)

The server emulation program module simulates the server program for a client program. The simulated server (hereinafter referred to as the SimServer) behaves in relation to the client program exactly like the server for which it stands in place thereof. This means: the SimServer receives data from the client and makes data available to the client. The client works exactly as though it were connected directly to the server. In other words:
the SimServer emulates the data streams associated with the server program and sends them to the client program;
the SimServer receives the data streams dispatched by the client program and stores them on the transportable data storage means; and
the SimServer sends data which were earlier stored on the transportable data storage means and which were received by the server program itself, to the client program.

The data to be transmitted from the SimServer to the client are disposed in the stored data on a transportable data storage means. For the actual communication functions the SimServer—as described hereinafter—makes use of a function program (also referred to as the F-API).

Client Emulation Program Module (Simulated Client)

An associated client is simulated for the server. The simulated client (hereinafter referred to as the SimClient) behaves in relation to the server program precisely like the client for which it stands in place thereof. This means: the SimClient receives data from the server and sends data to the server. The server operates exactly as though it were connected directly to the client. In other words:
the SimClient emulates the data streams associated with the client program and sends them to the server program by way of the data network;
the SimClient receives the data streams sent by the server program and stores them on the transportable data storage means; and
the SimClient sends data which were stored earlier on the transportable data storage means and which were received by the SimServer from the client program itself to the server program.

The data to be transmitted from the SimClient by way of the network to the server are in the stored data on a transportable data storage means. For the actual communication function the SimClient—as described hereinafter—makes use of a function program (also referred to as the F-API).

The SimClient and the SimServer should not be active at the same time. It will be noted that they always operate with the same stored data on the transportable data storage means 6 (see FIG. 1). The stored data also includes data which client and server require for mutual authentication. Those data are associated with an e-mail account and are referred to hereinafter as account data.

Nameserver Emulation Program Module (Simulated DNS)

The communication program, besides the SimServer and SimClient modules, further comprises a simulated DNS server (hereinafter referred as the SimDNS). The “Domain Name System”, referred by the abbreviation DNS, is a name service for the Internet, which was introduced in order to be able to identify resources in the network more easily than just with numerical IP addresses. The DNS is based for that purpose on a hierarchical structure, beginning from the zero domain, the top level domains (for example “.de” or “.org”) and the second level domains. The individual hierarchy stages are referred to as zones and defined in zone files.

Applications which communicate using TCP/IP by way of the Internet usually operate with domain names which first have to be converted by DNS servers into IP addresses. Those DNS servers administer the domain name data. In the case of a network connection, the client firstly asks whether the IP address of the DNS server or servers is deposited in the TCP/IP configuration. If that is not the case the IP address is allocated to the computer upon establishing the on-line connection by the provider or server in the network.

If however there is no network connection, the communication software according to the invention simulates for that purpose a DNS server, the SimDNS.

The SimServer module is executed on the same computer as the client program. So that a connection can be established, a configured TCP/IP protocol and SimDNS is required just as in the network. In order to install the TCP/IP protocol a virtual network adaptor is installed as a carrier in the system. The address of the home computer (for example 127.0.0.1) is entered in the TCP/IP protocol as the IP address of the DNS server. Thus in the event of enquiries for domain names which are known to it the SimDNS always refers to its own computer.

If the TCP/IP client looks for the connection to its configured server, it is referred to the SimDNS module by way of the DNS settings of the virtual network adaptor. The SimDNS module checks the domain name in the account data. If the domain name is present the SimDNS module also answers the TCP/IP client with the IP address 127.0.0.1. The TCP/IP client then finds the SimServer module at that address. The TCP/IP client announces itself with its account data at the SimServer module and is authenticated. The data are thereupon exchanged.

Function Program (F-API)

An API (Application Programmable interface) is the open programming interface of an application or an operating system. The methods of an API make it possible to integrate given functions into various program modules and to permit communication between various applications.

In the present example the F-API prepares the following common functionalities for the SimClient, SimServer and SimDNS modules:
reading processes
writing processes
attachment processes
erasure processes
positioning processes (addressing processes)
verification processes
authorization processes
encryption processes

The SimClient and the SimServer have recourse to the functions of the F-API for manipulations of the stored data.

Activation of the described program modules is effected in accordance with the matrix shown in FIG. 3. A distinction is drawn between the states of whether the data storage means is connected to a home computer of the user or to another external computer. That distinction can be made by interrogating one or more identifiers uniquely associated with the home computer (for example the name of the computer, the serial number or the serial number of the operating system, and so forth). Here, the computer of the user to whom the transportable data storage means belongs is identified as the home computer. Any other computer is an external computer.

As stated, a distinction is drawn between the home and the external computers, on the basis of a unique feature of the computer. That feature is deposited in the configuration of the communication software.

A distinction is drawn between the states on-line (connection to the data network active) and off-line (network connection inactive), on the basis of the server program or programs defined in the account data being attainable.

The SimServer is generally active on the home computer, particularly when there is no connection to the data network. In that state the SimServer permits communication by emulating the remote server.

If the home computer is on-line, it can communicate directly by way of the data network. The SimServer is not required but on the contrary would interfere with the on-line communication. The SimClient is generally inactive on the home computer but can be activated manually in order to use the home computer as the communications computer.

Whether the SimServer and SimDNS modules can be activated in the quadrant B2 in FIG. 3 depends on the application. In the e-mail example quadrant B2 describes a client/client communication without using servers.

As mentioned the method according to the invention is described with reference to the example of e-mail dispatch. Transport of e-mails on the Internet is effected as a conventional TCP/IP communication using the SMTP protocol (Simple Mail Transfer Protocol). The SMTP protocol regulates the transmission of an e-mail from one computer connected to the Internet to another.

The progress of a typical SMTP dialog in an e-mail transmission includes the phases of making connection, data transmission and breaking connection.

During the connecting phase the SMTP server is qualified by an “SMTP”, whereupon the client answers with “HELO” (presentation of the client at the server), which in turn is acknowledged by the server by a “PIPELINING” (sequentially settling a plurality of commands) and “8BITMIME” (data are transmitted as 8-bit-bytes). Identification of the sender is then effected by a “MAIL from:” (stating the sender of the message) and that of the receiver with “RCPT to:” (stating the receiver of the message). Transmission of the message begins with the statement “DATA” (text of the message in the ASCII format). Each line of the message is concluded by a “<CRLF>” (field conclusion), the end of the message forms the sequence “<CRLF>.<CRLF>”.

The SMTP server sends the client, after successful reception of the message in the return code a so-called message ID (MID) and the connection is terminated by a “QUIT” (termination of the SMTP dialog).

POP3 (Post Office Protocol Version 3) is a protocol for collecting e-mails which are ready on a computer which is referred to as the mail server. POP3 plays no part in terms of actual transport of e-mails by way of the Internet. As the average Internet user generally does not have a fixed IP address but has such an address allocated to him for the duration of the respective Internet connection, it makes no sense to deliver e-mails to him directly. Instead of that, the e-mails are stored on the mail server with a fixed IP address and can be collected there by way of the Internet using POP3.

If the home computer does not have a connection to the Internet, the communication software simulates the server program on a mail server which can locally communicate with an e-mail client, referred to as the client program, by the POP3/SMTP protocol. In addition the communication software simulates an e-mail client which can communicate with the program on a mail server by the POP3/SMTP protocol remotely, that is to say by way of a data network such as the Internet. SimServer and SimClient operate with a common database which is addressed by way of the F-API and implements intermediate storage of the data on the transportable data storage means. Data from that stored data are transmitted from the mail client to the mail server—and back again—, with the interposition of the communication software. The stored data on the transportable data storage means further contains the data for authentication in relation to the e-mail server and the e-mail client.

The transportable storage medium with the communication software makes it possible for users without an Internet access to operate with a mail client (for example MICROSOFT OUTLOOK®) as though they were connected directly to the Internet. The data which are produced in that situation are stored on the transportable data storage means. Users can send the data stored on the transportable data storage means by means of any external computer with Internet access. Data can be received from the Internet in the same operation. The received data can be further processed at the home computer with an e-mail client. The result is time-shifted e-mail communication by way of the Internet.

FIGS. 4.1 to 4.3 show portions of a flow chart of the communication software. The flow chart serves as a basis for all procedures which are described in the chapters hereinafter.

The starting point is starting the communication software with the check to ascertain whether the home computer or an external computer is involved (see FIG. 4.1). The various use and selection options for the user are embedded in that chart and will be clearly set forth with reference to the branchings.

The configuration procedure and possible scenarios for the user are discussed hereinafter. The scenarios vary on the basis of the various use and selection options.

The e-mail application serves as an example for a possible use for providing a clear picture in all scenarios. In these examples the client program is an e-mail client and for reasons for clarity in FIGS. 4.1 to 4.3 and hereinafter is frequently referred in abbreviated form as the client. The server program is the software running on an e-mail server and for reasons of clarity in FIGS. 4.1 to 4.3 and hereinafter is frequently referred to in abbreviated form as the server.

100 Start

The communication software is started (in general by the autostart function of the operating system). In step 100, on the basis of a unique feature (registry, serial number, and so forth) it checks whether it is executed on the home computer or an external computer (see FIG. 4.1).

The program steps which take place upon identification of the home computer can be seen from FIG. 4.2. The program steps which take place on an external computer are shown in FIG. 4.3

201 Home Computer: Check On-Line/Off-Line

The communication software sends a ping to a server address from the contact data. Ping is the abbreviation for “Packet INternet Groper”. That is a function with which it is possible to check whether a given computer is present on the network. If the server responds to the ping there is an on-line connection. If there is no response to the ping the computer is off-line.

302 Off-Line: Check SimDriver/No SimDriver

The existence of the driver which is associated with the emulation modules of the communication software, hereinafter referred to as the SimDriver, is verified in the system configuration of the computer.

403 No SimDriver: Installation Yes/No

If no SimDriver is present in the system the user is asked by a text window whether installation is to be executed. The user can make a choice by way of input means (for example keyboard, mouse).

504 Installation of the SimDriver

The SimDriver is installed in the system. Configuration: IP address of the DNS server is set to 127.0.0.1.

603 Configuration of the Account Data

The user inputs the data relating to his server connection, for example: e-mail: POP server, SMTP server, e-mail address, password. After successful installation of the SimDriver the computer should be re-booted at step 703 to start the communication software.

If the data storage means is connected to an external computer which is off-line—step 202—the configuration procedure is effected in the absence of SimDrivers as shown in FIG. 4.3.

406 No SimDriver: Installation Yes/No

No SimDriver is present in the system. A user decision as to whether installation is to be effected. That installation permits transmission of data stored on the data storage means to that external computer. In that case the SimDriver is installed in the system—step 508—, wherein the IP address of the DNS server is configured as 127.0.0.1. The computer is re-booted at step 606. If no installation on the external computer is selected at step 406, the communication program terminates.

Described hereinafter are the application scenarios, that is to say use of the communication software on the one hand on a home computer and on the other hand on an external computer which, with an active network connection, is also referred as the communications computer.

### EXAMPLE A

### Home Computer Without Internet Access

E-mails drafted on a home computer are to be sent from any external computer with an active Internet access. The home computer does not have an active Internet access. An e-mail client is set up on the home and the external computers.

The communication software is installed and configured on the home computer.

The Procedure on the Home Computer

When the portable data storage means is connected, the communication software is started in step 100 (mostly autostart) and the home computer/external computer check is effected. The home computer is recognized and in step 201—as described above—a check is made to ascertain whether an Internet connection is active (see FIG. 4.2).

302 Off-line: SimDriver/No SimDriver Check

The existence of the SimDriver is verified in the system configuration of the computer.

402 SimDriver Present/Start SimServer & SimDNS

A SimDriver was found in the system. The SimServer and SimDNS modules are activated. The SimClient remains deactivated.

503 Client: Domain Name to SimDNS

The client program, here an e-mail client such as for example MICROSOFT OUTLOOK, sends the domain name (POP/SMTP address) from the account data to the DNS server specified in the SimDriver configuration. The client program finds the SimDNS module under that address.

602 SimDNS: Reply with 127.0.0.1=Localhost to Client

The SimDNS module finds the domain name in the account data. The SimDNS module gives the IP address 127.0.0.1 to the client.

702 Client: Connection to SimServer

The client establishes the connection to the SimServer.

802 Authentication of the Client

The client is authenticated in relation to the SimServer by way of the account data.

902 Begin Data Exchange

The exchange of data is implemented using the routines made available by the F-API.

The Procedure on the External Computer

After the communication software is started and the home computer/external computer check is made at step 100 the external computer is detected and it is determined in step 202 that it is on-line (see FIG. 4.2).

303 On-line: Deactivation of the SimDriver

The communication software deactivates the SimDriver. The data of the SimDriver entered in the configuration (address of the DNS server) are no longer taken into consideration.

404 SimClient: Automatic Start

The SimClient module is activated. The SimServer and SimDNS modules remain deactivated.

506 SimClient: Domain Name to DNS Server

The SimClient is started manually by the answer to a question in an inquiry window. The SimClient sends the domain name (POP/SMTP address) from the account data which are stored on the transportable data storage means to the DNS server specified in the computer configuration.

604 DNS Server: Reply with IP Address to SimClient

The DNS server notifies the SimClient of the IP address associated with the domain name.

704 SimClient: Connection to Server

The SimClient establishes the connection to the program on the e-mail server.

803 Authentication of the SimClient

The SimClient is authenticated in relation to the server by way of the account data stored on the data storage means. Authentication is therefore effected with the data with which the client program on the home computer previously identified itself with respect to the SimServer.

903 Begin Data Exchange

The exchange of data is executed.

The data received during the data exchange by the SimClient by way of the data network are written to the data storage means. When the data storage means is later connected to the home computer they can be received by the e-mail client installed there and stored.

### EXAMPLE B

### Home Computer with Internet Access

Precondition: the communication software is already configured on the home computer. It can also be fixedly installed here. E-mails with large amount of data should be sent in accordance with the method described in Example A from any external computer with Internet access which preferably has a high transmission speed. In cases in which the home computer has Internet access (for example in the case of a laptop used when traveling in a hotel) the home computer should also be used for e-mail transmission.

Without connecting the portable data storage means to the home computer the communication program is not activated and e-mails can be simply sent and received by way of the e-mail client of the home computer.

When the portable data storage means is connected steps 100 and 201 are executed. In step 301 the communication software deactivates the SimDriver. The data of the SimDriver which are entered in the configuration (address of the DNS server) are no longer taken into consideration.

401 Manual Start of the SimClient: Yes/No

The SimClient can be deactivated by manual input if the data storage means is only to be used as a drive and is not to implement a communication function of the method according to the invention. In that case the e-mail communication is effected—as described hereinbefore—by way of the normal e-mail client on the home computer.

Alternatively, the SimClient can be started manually. In that case the home computer with Internet connection is used as a communications computer. Prior to activation of the SimClient the user must ensure that the amounts of data stored on the data storage means are not excessively large so that an on-line connection with a possibly narrow bandwidth is not overloaded. The SimServer and SimDNS modules always remain deactivated as long as the computer is on-line.

501 SimClient: Domain Name to DNS Server

After the SimClient is started manually it sends the domain name (POP/SMTP address) from the account data of the home computer (they correspond to the account data stored on the data storage means) to the DNS server specified in the computer configuration.

601 DNS Server: Answers with IP Address to SimClient

The DNS server gives the SimClient the IP address belonging to the domain name.

701 SimClient: Connection to Server

The SimClient establishes the connection to the server.

801 Authentication of the SimClient

The SimClient is authenticated with respect to the server by way of the account data.

901 Begin Data Exchange

The exchange of data is executed with the home computer being used as the communications computer. In other words, the data previously stored by means of the home computer on the transportable data storage means are read out of the data storage means by way of the SimClient running on the home computer, and are transmitted to the server by way of the Internet.

Use of the home computer can be effected for example when an e-mail message is drafted while traveling (in an aircraft or on a train) and stored on the data storage means by means of the e-mail client of the home computer by way of the SimServer and later the home computer is connected to the Internet, for example in a lounge in an airport or in a hotel room. An external computer does not have to be used with this data communication.

### EXAMPLE C

### Data Transmission without Network

This example shows the atypical use of the program according to the invention without the use or a data network. The communication software is installed on the home computer. An e-mail is transported from the home computer by means of the data storage means to precisely the external computer which is to be the receiver of the e-mail. In other words, the data storage means is transported to a computer whose e-mail client is configured with the account data of the receiver of an e-mail stored on the data storage means. In that case, the Internet is not used for the e-mail transmission.

Dispatch of the e-mail on the home computer is carried out as described in Example A.

The Procedure on the External Computer

In step 100 the communication software is started and in the checking procedure it is determined that this is not the home computer. As can be seen from FIG. 4.3 step 202 involves checking by a ping whether the external computer is on-line or off-line. It is determined that the external computer is off-line and therefore cannot be used as the communications computer.

304 Off-Line: SimDriver/No SimDriver Check

The existence of the SimDriver is verified in the system configuration of the computer.

405 SimDriver Present/Start SimServer & SimDNS

A SimDriver was found in the system. The SimServer and SimDNS modules are activated. The SimClient remains deactivated.

507 Client: Domain Name to SimDNS

The e-mail client on the external computer sends the domain name (POP/SMTP address) from the account data to the DNS server specified in the SimDriver configuration. The client finds the SimDNS module at that address.

605 SimDNS: Answer with 127.0.0.1=Localhost to Client

The SimDNS module finds the domain name in the account data. The SimDNS module passes the IP address 127.0.0.1 to the client.

705 Client: Connection to SimServer

The e-mail client on the external computer establishes the connection to the SimServer.

804 Authentication of the Client

The e-mail client is authenticated in relation to the SimServer by way of the account data.

904 Begin Data Exchange

The exchange of data with coincident account data is executed. In other words, an e-mail previously stored on the memory stick is transmitted by the SimServer to the e-mail client of the external computer. The e-mail was previously stored on the data storage means by the SimServer on the home computer, using the e-mail client thereof. The e-mail exchange is therefore executed without a data network using the transportable data storage means by communication of the SimServer firstly with the e-mail client of the home computer and then with the e-mail client of the receiver computer.

That direct client/client communication is the subject-matter of claim 16.

1. A method of data communication with a client program, which is intended for data exchange with a server program by way of a data network, characterized by the use of a transportable data storage means and by the following steps:
A) data streams associated with the server program are emulated and sent to the client program;
B) data streams sent by the client program are received and stored on the transportable data storage means;
C) if data has been previously sent by the server program and is stored on the transportable data storage means, sending this data to the client program;
D) data streams associated with the client program are emulated and sent to the server program;
E) data streams sent by the server program are received and stored on the transportable data storage means; and
F) if data has been dispatched by the client program and is stored on the transportable data storage means, sending this data to the server program.

2. A method according to claim 1 characterized in that in step D the data streams are transmitted to the server program by way of the data network.

3. A method according to claim 1 characterized in that loaded into the main memory of a home computer is a server emulation program module which includes software code portions for executing steps A to C, and that loaded into the main memory of a communications computer which is connected to the data network is a client emulation program module which includes software code portions for executing steps D to F.

4. A method according to claim 3 characterized in that a domain name sent by the client program is received by a nameserver emulation program module and associated with a given IP address and that the nameserver emulation program module sends that IP address back as a reply to the client program.

5. A method according to claim 4 characterized in that at least one of the following program modules:
server emulation program module,
client emulation program module, and
nameserver emulation program module
is stored on the transportable data storage means.

6. A method according to claim 5 characterized in that at least one of said program modules, namely the server emulation program module, the client emulation program module and the nameserver emulation program module, is loaded from the transportable data storage means directly into the main memory of a computer.

7. A method according to claim 6 characterized in that when the transportable data storage means is connected to a computer at least one of said program modules is automatically loaded into the main memory of the computer.

8. A method according to claim 4 characterized in that at least one of said program modules is installed on a computer, namely
the server emulation program module on the home computer,
the nameserver emulation program module on the home computer, and
the client emulation program module on the communications computer
by storing the program code with associated installation data and installation files is stored on a mass storage means and by writing required entries into the operating system of the computer.

9. A method according claim 3 characterized in that a communication program is loaded into the main memory of the home computer and of the communications computer, which includes the server emulation program module and the client emulation program module.

10. A method according to claim 9 characterized in that the communication program further includes the nameserver emulation program module.

11. A method according to claim 3 characterized in that only either the server emulation program module or the client emulation program module is executed on one computer at a given time.

12. A method according to claim 11 characterized in that a test program module checks whether the transportable data storage means is connected to the home computer or to a computer linked to the data network, wherein
the server emulation program module is executed if it is determined that the transportable data storage means is connected to the home computer, and
the client emulation program module is executed if it is determined that the transportable data storage means is connected to a computer linked to the data network.

13. A method according claim 3 characterized in that the program modules are coupled to a function program which executes data transmission processes and data conversion processes.

14. A method according to claim 13 characterized in that the data transmission processes include at least one of the following processes:
reading data out of a data storage means,
writing data into a data storage means,
associating attachments to given data sets,
erasing data from a data storage means,
verifying complete transmission and storage of data, and
authorizing the transmission and reception of data from and to a given counterpart location.

15. A method according to claim 13 characterized in that the data conversion processes include encryption and/or decryption of data.

16. A method of data communication between a first client program and a second client program characterized by the use of a transportable data storage means and by the following steps:
A) data streams associated with a server program are emulated and sent to the first client program;
B) data streams dispatched by the first client program are received and stored on the transportable data storage means;
C) the data storage means is connected to a computer on which a second client program is running, and
D) the data stored in step B) on the transportable data storage means are sent to the second client program.

17. A computer program product for data communication with a client program, which is intended for data exchange with a server program by way of a data network by means of a transportable data storage means, the program comprising software code portions for executing the following steps:
A) emulating data streams associated with the server program and sending these data streams to the client program;
B) receiving data streams sent by the client program and storing these data streams on the transportable data storage means;
C) if data has been previously sent by the server program and is stored on the transportable data storage means, sending this data to the client program;
D) emulating data streams associated with the client program and sending these data streams to the server program;
E) receiving data streams sent by the server program and storing these data streams on the transportable data storage means; and
F) if data has been dispatched by the client program and is stored on the transportable data storage means, sending this data to the server program.

18. A computer program product according to claim 17 characterized in that in step D the data streams are transmitted to the server program by way of the data network.

19. A computer program product according to claim 17 characterized in that it comprises a server emulation program module which is to be loaded into the main memory of a home computer and which includes software code portions for executing steps A to C, and that it comprises a client emulation program module which is to be loaded into the main memory of a communications computer being connected to the data network and which includes software code portions for executing steps D to F.

20. A computer program product according to claim 17 characterized in that it further comprises a nameserver emulation program module with software code portions for receiving a domain name sent by the client program, for associating said domain name with a given IP address and for sending said IP address back as a reply to the client program.

21. A computer program product according to claim 20 characterized in that at least one of the following program modules:
server emulation program module,
client emulation program module, and
nameserver emulation program module
is stored on the transportable data storage means.

22. A computer program product according to claim 21 characterized in that at least one of said program modules, namely the server emulation program module, the client emulation program module and the nameserver emulation program module, is loaded from the transportable data storage means directly into the main memory of a computer.

23. A computer program product according to claim 22 characterized in that it is linked with an autostart function so that when the transportable data storage means is connected to a computer at least one of said program modules is automatically loaded into the main memory of the computer.

24. A computer program product according to claim 20 characterized in that at least one of said program modules is installed on a computer, namely
the server emulation program module on the home computer,
the nameserver emulation program module on the home computer, and
the client emulation program module on the communications computer
by storing the program code with associated installation data and installation files is stored on a mass storage means and by writing required entries into the operating system of the computer.

25. A computer program product according to claim 19 characterized in that only either the server emulation program module or the client emulation program module is executed on one computer at a given time.

26. A computer program product according to claim 25 characterized in that it comprises a test program module with software code portions for checking whether the transportable data storage means is connected to the home computer or to a computer linked to the data network, wherein
the server emulation program module is executed if it is determined that the transportable data storage means is connected to the home computer, and
the client emulation program module is executed if it is determined that the transportable data storage means is connected to a computer linked to the data network.

27. A computer program product according claim 19 characterized in that it further comprises a function program with software code portions for executing data transmission processes and data conversion processes.

28. A computer program product according to claim 27 characterized in that the data transmission processes include at least one of the following processes:
reading data out of a data storage means,
writing data into a data storage means,
associating attachments to given data sets,
erasing data from a data storage means,
verifying complete transmission and storage of data, and
authorizing the transmission and reception of data from and to a given counterpart location.

29. A computer program product according to claim 27 characterized in that the data conversion processes include encryption and/or decryption of data.

30. A computer program product for data communication between a first client program and a second client program by means of a transportable data storage means, the program comprising software code portions for executing the following steps when running on a computer hosting the first client program and connected to the transportable data storage means:
A) emulating data streams associated with a server program and sending these data streams to the first client program;
B) receiving data streams dispatched by the first client program and storing these data streams on the transportable data storage means;
when running on a computer hosting the second client program and connected to the transportable data storage means
D) reading the data stored in step B) on the transportable data storage means and sending these data to the second client program.

31. A method of performing data communication of a client program, wherein the data communication is intended for data exchange with a server program by way of a data network, the method comprising:
(A) performing, in a first computer system:
(1) emulating data streams associated with the server program and sending them to the client program;
(2) receiving data streams sent by the client program and intended for network transmission to the server program; and
(3) storing the data streams on the transportable data storage means;
(B) loading the transportable data storage means on a second computer which has network access; and
(C) performing, in the second computer system:
(1) emulating data streams associated with the client program and sending them to the server program; and
(2) receiving and storing data streams sent by the server program on the transportable data storage means.

32. The method of claim 31
wherein said performing, in the first computer system, further comprises:
sending data which was previously dispatched by the server program and stored on the transportable data storage means to the client program.

33. The method of claim 31
wherein said performing, in the second computer system, further comprises:
sending data which were dispatched by the client program and stored on the transportable data storage means to the server program.

34. The method of claim 31, where in step (C)(1) the data streams are transmitted to the server program by way of the data network.

35. The method of claim 31, wherein a server emulation program module which includes software code portions for executing step A is loaded into the main memory of a home computer, and wherein a client emulation program module which includes software code portions for executing step C is loaded into the main memory of a communications computer which is connected to the data network.
